(19) United States
(12) Patent Application Publication
(10) Pub. No.: US 2024/0100691 A1
(43) Pub. Date: Mar. 28, 2024

(54) Self-propelled Device

(71) Applicant: DMG MORI CO., LTD., Nara (JP)

(72) Inventors: Hideki NAGASUE, Nara (JP); Masaaki NAKAGAWA, Nara (JP)

(73) Assignee: DMG MORI CO., LTD., Nara (JP)

(21) Appl. No.: 18/535,727

(22) Filed: Dec. 11, 2023

Related U.S. Application Data
(63) Continuation of application No. PCT/JP2022/017885, filed on Apr. 15, 2022.

(30) Foreign Application Priority Data
Jun. 14, 2021 (JP) 2021-098821

(51) Int. Cl. B25J 9/16; B25J 5/00

(52) U.S. Cl. CPC B25J 9/16; B25J 5/00

(57) ABSTRACT

A self-propelled device includes a traveling body and a robot arm that is mounted on traveling body. Robot arm includes a base portion that is turnably connected to traveling body; an arm portion that is connected to base portion; and an end effector that is detachably attached to a distal end of arm portion and performs work on a target. Self-propelled device further includes an additional apparatus that includes at least one of an antenna, an imaging device, a laser sensor, an ultrasonic sensor, and a lighting device, and is attached to arm portion.

### CROSS REFERENCE TO RELATED APPLICATIONS

The present application is a continuation of International Application No. PCT/JP2022/017885 filed on Apr. 15, 2022, which claims priority to Japanese Patent Application No. 2021-098821 filed on Jun. 14, 2021 with the Japan Patent Office, the entire contents of each of which are incorporated herein by reference.

### BACKGROUND OF THE INVENTION

### Field of the Invention

The present disclosure relates to a self-propelled device.

### Description of the Background Art

In a production system such as a factory, unmanned operation is desired. In order to realize the unmanned operation, development of a self-propelled device has been advanced. The self-propelled device conveys a workpiece before machining, a tool, and the like to each machine tool, or collects the workpiece that has been machined by the each machine tool, the tool used, and the like.

As the self-propelled device, for example, an automated guided vehicle (AGV) that moves along a track such as a magnetic tape on a floor is known. Further, in recent years, an autonomous mobile robot (AMR) that automatically avoids a person or an obstacle and autonomously travels has also been developed. Such autonomous mobile robot automatically calculates a traveling route based on a map. For example, the map is generated by remotely controlling the autonomous mobile robot with an information device (for example, a personal computer, a tablet, or a smartphone) equipped with a browser.

Japanese Patent Laying-Open No. 2019-8359 discloses, as the self-propelled device, a moving device including: a distance measurement device that rotationally drives a light projection portion emitting projected light and outputs distance measurement data based on reception of reflected light obtained by reflecting the projected light off a target to be measured; a map creation portion that creates map information based on the distance measurement data; and an obstacle sensor that detects an obstacle.

Japanese Patent No. 6779398 discloses a self-propelled device including omni wheels.

Japanese Patent Laying-Open No. 2021-6359 discloses a self-propelled device including a traveling carriage portion and a robot arm. The self-propelled device has an end effector at a distal end of the robot arm. The end effector includes a vision sensor (an imaging device) that images a workpiece in a work tray disposed in the self-propelled device.

### SUMMARY OF THE INVENTION

As described above, the self-propelled device includes an additional apparatus such as a communication antenna, an imaging device, and a sensor. The present disclosure provides a self-propelled device capable of improving usability of the additional apparatus with a simple configuration.

### Solution to Problem

According to an aspect of the present disclosure, the self-propelled device includes a traveling body and a robot arm that is mounted on the traveling body. The robot arm includes a base portion that is turnably connected to the traveling body; an arm portion that is connected to the base portion; and an end effector that is detachably attached to a distal end of the arm portion and performs work on a target. The self-propelled device further includes the additional apparatus that includes at least one of the antenna, the imaging device, a laser sensor, an ultrasonic sensor, and a lighting device and that is attached to the arm portion.

According to such configuration, since the additional apparatus acts together with the arm portion as the robot arm acts, degrees of freedom of a position, a form, or an orientation of the additional apparatus can be increased. Accordingly, the usability of the additional apparatus can be improved with the simple configuration.

Preferably, the arm portion includes a first arm portion that is pivotally connected to the base portion; a second arm portion that is pivotally connected to the first arm portion; and a wrist portion that is pivotally connected to the second arm portion and detachably attached with the end effector. The additional apparatus is disposed at a joint portion where the second arm portion is connected to the first arm portion.

According to such configuration, since the additional apparatus is arranged at a corner portion that is a position away from the traveling body, and formed by the first arm portion and the second arm portion at the joint portion, interference with the traveling body or the robot arm in use of the additional apparatus hardly occurs.

Preferably, the self-propelled device further includes a wiring that is routed from the additional apparatus toward the traveling body. The additional apparatus is attached to the first arm portion.

According to such configuration, since the additional apparatus is attached to a position closer to the traveling body as compared with a case where the additional apparatus is attached to the second arm portion, routing of wiring from the additional apparatus toward the base portion becomes easy.

Preferably, the additional apparatus is attached to the second arm portion.

According to such configuration, the degrees of freedom of the position, the form, or the orientation of the additional apparatus can be further increased since actions of the second arm portion with respect to the first arm portion are added, as compared with a case where the additional apparatus is attached to the first arm portion.

Preferably, the self-propelled device further includes a control device that controls the self-propelled device. The control device controls the robot arm to cause the arm portion to be in a form that the first arm portion extends upward from the base portion toward the joint portion, the first arm portion and the second arm portion are bent at the joint portion, and the second arm portion extends downward from the joint portion toward the wrist portion, when the traveling body travels.

According to such configuration, the additional apparatus can be arranged at a higher position when the traveling body travels.

Preferably, the traveling body has a top surface. The base portion is connected to the top surface.

According to such configuration, the additional apparatus can be arranged at the higher position.

Preferably, the self-propelled device further includes a control device that controls the self-propelled device. The additional apparatus includes the antenna. The control device sequentially acquires mutual position information between the antenna and an external antenna communicating with the antenna when the traveling body travels, and controls the robot arm to change an orientation of the antenna based on the position information acquired.

According to such configuration, a good communication state can be obtained between the antenna and the external antenna even though a positional relationship between the antenna and the external antenna changes from moment to moment as the traveling body travels.

Preferably, the additional apparatus includes the lighting device and the imaging device capable of imaging a region to be irradiated by the lighting device.

According to such configuration, the region to be irradiated by the lighting device can be imaged by the imaging device while the region is being moved by causing the arm portion to act.

Preferably, the self-propelled device further includes a control device that controls the self-propelled device. The additional apparatus includes the laser sensor or the ultrasonic sensor that receives reflected light of a laser beam or an ultrasonic wave reflected by an object around the self-propelled device while irradiation is being performed with the laser beam or the ultrasonic wave. The control device controls the robot arm to cause the arm portion to act while the irradiation is being performed with the laser beam or the ultrasonic wave from the laser sensor or the ultrasonic sensor. The control device measures a distance from the self-propelled device to the object based on a period from the irradiation with the laser beam or the ultrasonic wave to reception of the laser beam or the ultrasonic wave, and generates map data around the self-propelled device.

According to such configuration, an irradiation direction of the laser beam or the ultrasonic wave can be changed by causing the arm portion to act. Accordingly, the map data can be generated more accurately with smaller number of laser sensors or ultrasonic sensors.

### Advantageous Effects of Invention

According to the present disclosure, it is possible to enhance the usability of the additional apparatus to be added to the self-propelled device.

### BRIEF DESCRIPTION OF THE DRAWINGS

FIG. 1 is a diagram for illustrating a schematic configuration of a traveling system.

FIG. 2 is a perspective view illustrating a self-propelled device.

FIG. 3 is a top view illustrating a traveling body portion.

FIG. 4 is a diagram illustrating a device configuration related to action control of the self-propelled device.

FIG. 5 is a diagram illustrating a function configuration related to the action control of the self-propelled device.

FIG. 6 is a diagram illustrating actions of the self-propelled device.

FIG. 7 is a flowchart illustrating a flow of controlling an orientation of an antenna.

FIG. 8 is a perspective view illustrating the self-propelled device of another embodiment.

FIG. 9 is a diagram illustrating a function configuration related to the action control of the self-propelled device.

FIG. 10 is a flowchart illustrating a flow of controlling an orientation of a laser sensor during normal traveling.

FIG. 11 is a flowchart illustrating a flow of controlling the orientation of the laser sensor during creation of a three-dimensional map.

FIG. 12 is a perspective view illustrating the self-propelled device of still another embodiment.

### DESCRIPTION OF THE PREFERRED EMBODIMENTS

The following will describe each embodiment according to the present invention with reference to the drawings. In descriptions below, the same parts and components are denoted by the same reference numerals. The names and functions thereof are also the same. Therefore, detailed descriptions thereof will not be repeated. Note that each embodiment and each variation to be described below may be appropriately and selectively combined.

Further, in the following, a self-propelled device in which a robot arm is combined with an autonomous mobile robot (AMR) will be described as an example. The robot arm is, for example, a cooperative robot. Note that, in the self-propelled device, the robot arm may be combined with an automated guided vehicle (AGV) instead of the autonomous mobile robot.

### First Embodiment

<System Configuration>

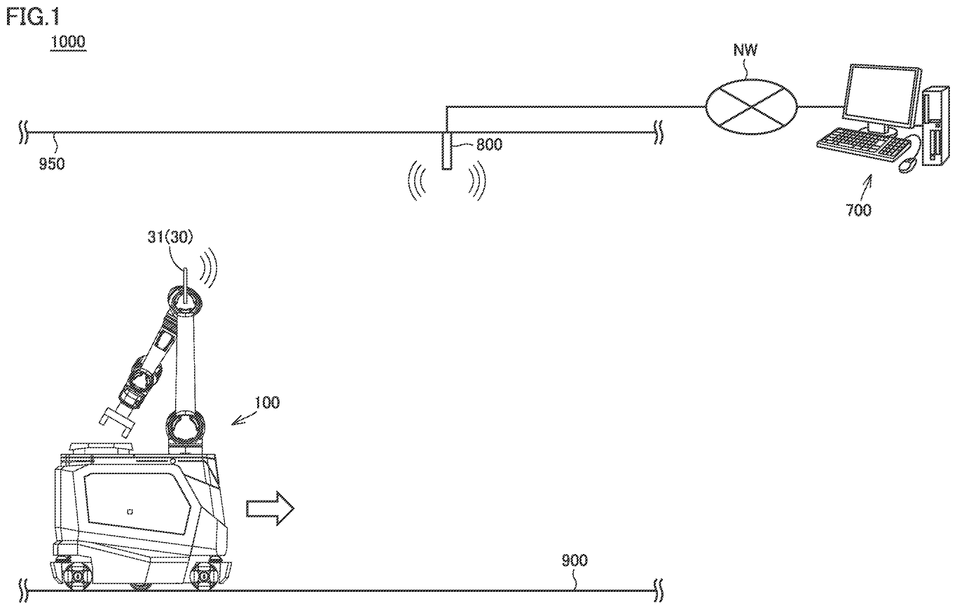

FIG. 1 is a diagram illustrating a schematic configuration of a traveling system 1000 of the present embodiment.

As illustrated in FIG. 1, traveling system 1000 includes a self-propelled device 100, an information processing device 700, and an antenna 800. Information processing device 700 is communicably connected to antenna 800 via a network NW. Note that, in the present example, one self-propelled device 100 and one antenna 800 are illustrated, but the present invention is not limited thereto.

Self-propelled device 100 travels on a floor surface 900 in a building. Self-propelled device 100 includes an additional apparatus 30. In the present example, additional apparatus 30 includes at least an antenna 31. Antenna 800 is installed on a ceiling 950 of the building. Note that antenna 800 may be installed on a wall surface. Typically, in the building, a plurality of antennas 800 are installed at intervals. Typically, one or more machine tools (not illustrated) are installed in the building.

Self-propelled device 100 communicates with information processing device 700 connected to network NW via antenna 800. Specifically, self-propelled device 100 transmits a radio wave from antenna 31. The radio wave is received by antenna 800. On the other hand, a data signal transmitted from information processing device 700 is transmitted via antenna 800. The radio wave based on the data signal is received by antenna 31 of self-propelled device 100. In this way, self-propelled device 100 performs bidirectional communication with information processing device 700.

Self-propelled device 100 receives an action instruction from information processing device 700. For example, self-propelled device 100 receives a travel indication and a stop indication. Further, self-propelled device 100 receives a creation indication of a three-dimensional map to be described later from information processing device 700. Moreover, self-propelled device 100 can upload the three-dimensional map created to information processing device 700. Self-propelled device 100 can also transmit information of a current position of self-propelled device 100 to information processing device 700. Self-propelled device 100 and information processing device 700 exchange various types of information.

The communication above is implemented by, for example, a wireless local area network (LAN). Alternatively, the communication above is implemented by a wireless system for a mobile body. For example, a fourth generation communication system (4G) or a fifth generation communication system (5G) can be used as the wireless system for the mobile body.

Information processing device 700 is, for example, a server. Information processing device 700 may be a user terminal that operates self-propelled device 100. The user terminal is, for example, a tablet terminal or a smartphone. A user can control traveling of self-propelled device 100 via information processing device 700.

<Configuration of Self-Propelled Device>

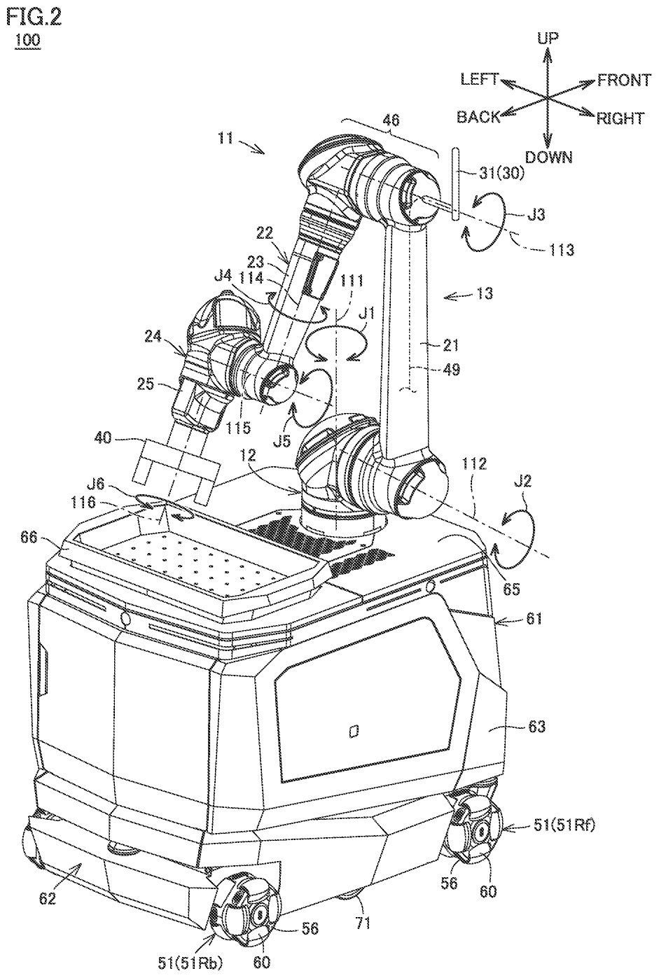

FIG. 2 is a perspective view illustrating self-propelled device 100.

In FIG. 2 and the drawings below, six directions including front, back, right, left, up, and down directions are appropriately illustrated. The front direction and the back direction are running directions in a case where self-propelled device 100 travels straight, and opposite to each other. The right direction is a right hand direction in a case of viewing forward from self-propelled device 100. The left direction is a left hand direction in a case of viewing forward from self-propelled device 100, and is a direction opposite to the right direction. The up direction is an air side viewed from self-propelled device 100, and the down direction is a floor surface side on which self-propelled device 100 travels.

Note that, in the present embodiment, although a direction where a robot arm 11 is located with respect to a tray 66 to be described later is referred to as front direction, and an opposite direction is referred to as back direction, there is no particular limitation as to which direction is referred to as front direction and which direction is referred to as back direction.

As illustrated in FIG. 2, self-propelled device 100 has a traveling body 61, robot arm 11, antenna 31 as additional apparatus 30, and a wiring 49. Traveling body 61 is able to travel by wheel driving using a motor. Robot arm 11 is mounted on traveling body 61. A distal end of robot arm 11 is equipped with an end effector 40. End effector 40 is detachably attached to the distal end of robot arm 11 and performs work on a target. In the present example, a gripping hand is connected to robot arm 11 as end effector 40. Self-propelled device 100 is able to grip a target to be conveyed by end effector 40.

Traveling body 61 has a traveling body portion 62 and a cover portion 63. Cover portion 63 is disposed on traveling body portion 62. Cover portion 63 includes a cover body forming an internal space on traveling body portion 62, and accommodates therein, for example, a driving motor for robot arm 11, a battery disposed as a power source for self-propelled device 100, or various control parts that control self-propelled device 100. Note that a structure of traveling body portion 62 will be described later in detail.

Cover portion 63 has a top surface 65. Tray 66 on which the target to be conveyed is placed is disposed on top surface 65. Robot arm 11 is connected to top surface 65. Robot arm 11 extends upward from top surface 65. A connection position of robot arm 11 to traveling body 61 is aligned with tray 66 in a front-back direction.

Note that the connection position of robot arm 11 to traveling body 61 is not particularly limited, and may be, for example, a side surface of cover portion 63 facing a horizontal direction.

Robot arm 11 is a program-controlled robot. In the present example, robot arm 11 is a perpendicular articulated robot. In detail, in the present example, robot arm 11 is a 6-axis robot having six degrees of freedom (six movable portions).

Robot arm 11 has a base portion 12 and an arm portion 13. Base portion 12 is rotatably connected to traveling body 61. Base portion 12 is rotatable about a rotation center axis 111. Rotation center axis 111 extends in a vertical direction. Base portion 12 extends on rotation center axis 111. Base portion 12 performs rotational movement about rotation center axis 111 (refer to an arrow J1).

Arm portion 13 is connected to base portion 12. Arm portion 13 extends in an arm shape from base portion 12.

Arm portion 13 has a first arm portion 21, a second arm portion 22, and a wrist portion 24. First arm portion 21 is connected to base portion 12 to be rotatable about a rotation center axis 112. Rotation center axis 112 extends in a direction orthogonal to rotation center axis 111. Rotation center axis 112 extends in the horizontal direction. First arm portion 21 extends from base portion 12 in a radial direction of rotation center axis 112. First arm portion 21 performs swinging movement about rotation center axis 112 (refer to an arrow J2).

Second arm portion 22 is connected to first arm portion 21 to be rotatable about a rotation center axis 113. Rotation center axis 113 extends in parallel with rotation center axis 112. Rotation center axis 113 extends in the horizontal direction. Second arm portion 22 extends from first arm portion 21 in a radial direction of rotation center axis 113.

Second arm portion 22 has a first rotation portion 23. First rotation portion 23 is rotatable about a rotation center axis 114. Rotation center axis 114 extends in the radial direction of rotation center axis 113. First rotation portion 23 extends on rotation center axis 114. Second arm portion 22 (first rotation portion 23) performs the swinging movement about rotation center axis 113 (refer to an arrow J3) and performs the rotational movement about rotation center axis 114 (refer to an arrow J4).

Wrist portion 24 is connected to second arm portion 22 (first rotation portion 23) to be rotatable about a rotation center axis 115. Rotation center axis 115 extends in parallel with rotation center axis 112 and rotation center axis 113. Rotation center axis 115 extends in the horizontal direction. Wrist portion 24 extends from second arm portion 22 (first rotation portion 23) in a radial direction of rotation center axis 115.

Wrist portion 24 has a second rotation portion 25. Second rotation portion 25 is rotatable about a rotation center axis 116. Rotation center axis 116 extends in the radial direction of rotation center axis 115. Second rotation portion 25 extends on rotation center axis 116. Wrist portion 24 (second rotation portion 25) performs the swinging movement about rotation center axis 115 (refer to an arrow J5) and performs the rotational movement about rotation center axis 116 (refer to an arrow J6).

End effector 40 for gripping the target to be conveyed is attached to a distal end of wrist portion 24 (second rotation portion 25). In other words, end effector 40 is attached to the distal end of arm portion 13.

Note that, in the present embodiment, robot arm 11 capable of controlling six axes (rotation center axes 111 to 116) has been described, but a robot arm capable of controlling multiple axes other than the six axes may be mounted on traveling body 61.

Antenna 31 is attached to arm portion 13. In detail, antenna 31 is arranged in first arm portion 21. In more detail, antenna 31 is arranged at a joint portion 46 where second arm portion 22 is connected to first arm portion 21. In the present example, joint portion 46 includes a part of second arm portion 22 and a part of first arm portion 21.

Wiring 49 is routed from antenna 31 toward traveling body 61. Wiring 49 connects antenna 31 and a control device 201 to be described later of self-propelled device 100. In the present example, wiring 49 functions as a communication line and a power supply line.

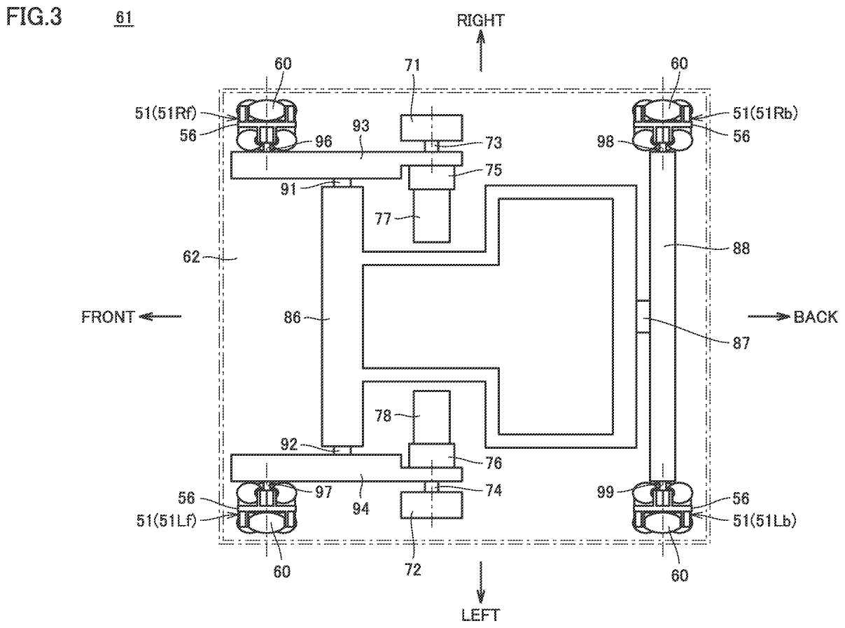

FIG. 3 is a top view illustrating traveling body portion 62 in FIG. 2.

As illustrated in FIG. 3, traveling body portion 62 has a first driving wheel 71, a first traveling motor 77, a second driving wheel 72, a second traveling motor 78, and a plurality of driven wheels 51 (51Rf, 51Lf, 51Rb, and 51Lb). Driven wheels 51 include omni wheels. Driven wheels 51 have wheels 56 and a plurality of rollers 60.

Traveling body portion 62 has a first axle 73, a second axle 74, a speed reducer 75, and a speed reducer 76. First traveling motor 77 is connected to first driving wheel 71 via speed reducer 75. Second traveling motor 78 is connected to second driving wheel 72 via speed reducer 76.

Traveling body portion 62 further has a frame 86, a first support arm 93, a second support arm 94, a first support shaft 91, a second support shaft 92, a third support arm 88, and a third support shaft 87.

Traveling body portion 62 further has a third axle 96, a fourth axle 97, a fifth axle 98, and a sixth axle 99. Driven wheel 51Rf is connected to first support arm 93 via third axle 96. Driven wheel 51Lf is connected to second support arm 94 via fourth axle 97. Driven wheel 51Rb is connected to third support arm 88 via fifth axle 98. Driven wheel 51Lb is connected to third support arm 88 via sixth axle 99.

Since a hardware configuration of such traveling body portion 62 is known, a detailed description of the configuration will not be repeated here. The following will describe moving directions of traveling body 61 according to traveling body portion 62.

Traveling body 61 travels straight in the front-back direction by applying mutually the same rotation to first driving wheel 71 and second driving wheel 72, and performs a turning action in a left-right direction by applying mutually different rotations to first driving wheel 71 and second driving wheel 72 (a differential two-wheel drive system). First driving wheel 71, second driving wheel 72, and driven wheels 51 cannot be steered leftward or rightward.

More specifically, traveling body 61 travels straight forward (advances) by rotating first driving wheel 71 and second driving wheel 72 forward at a mutually equal rotation rate. Traveling body 61 travels straight backward (retreats) by rotating first driving wheel 71 and second driving wheel 72 backward at the mutually equal rotation rate.

Traveling body 61 performs the turning action to the left direction (left turn) by rotating second driving wheel 72 forward and rotating first driving wheel 71 forward at a rotation rate higher than a rotation rate of second driving wheel 72. Traveling body 61 performs the turning action to the right direction (right turn) by rotating first driving wheel 71 forward and rotating second driving wheel 72 forward at a rotation rate higher than a rotation rate of first driving wheel 71.

Traveling body 61 performs a rotating action (left rotation) by rotating first driving wheel 71 forward and rotating second driving wheel 72 backward at the same rotation rate as the rotation rate of first driving wheel 71. Ideally, a rotation center of traveling body 61 in top view is on a first axis 121 and a second axis 122 and corresponds to center positions of first driving wheel 71 and second driving wheel 72.

Note that, in a case where first driving wheel 71 is rotated backward and second driving wheel 72 is rotated forward at the same rotation rate as the rotation rate of first driving wheel 71, a rotating action direction of traveling body 61 is reversed (right rotation) from a case above. “Turning action” in the present invention includes the actions of the right turn, the left turn, and the rotations (the left rotation and the right rotation) above.

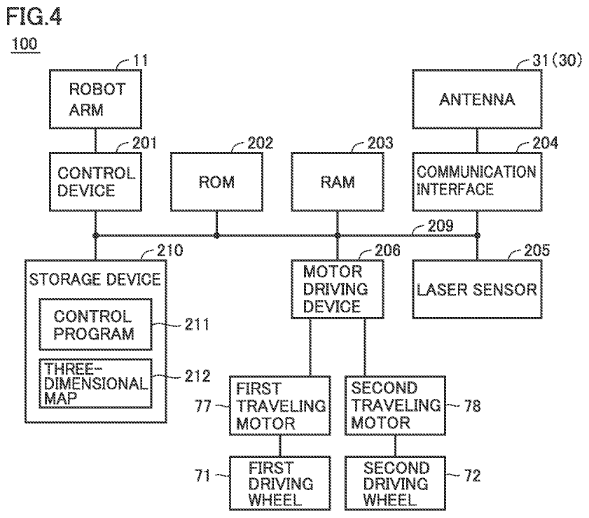

FIG. 4 is a diagram illustrating a device configuration related to action control of self-propelled device 100.

As illustrated in FIG. 4, self-propelled device 100 has control device 201, a read only memory (ROM) 202, a random access memory (RAM) 203, a communication interface 204, a laser sensor 205, a motor driving device 206, a storage device 210, robot arm 11, and antenna 31. These components are connected to a bus 209.

Control device 201 includes, for example, at least one integrated circuit. The integrated circuit may include, for example, at least one central processing unit (CPU), at least one graphics processing unit (GPU), at least one application specific integrated circuit (ASIC), at least one field programmable gate array (FPGA), or a combination thereof. As an example, control device 201 is a programmable logic controller (PLC).

Control device 201 controls the actions of self-propelled device 100 by executing various programs such as a control program 211 or an operating system. Control device 201 reads control program 211 from storage device 210 or ROM 202 to RAM 203 based on reception of a command of executing control program 211. RAM 203 functions as a working memory and temporarily stores various data required for executing control program 211.

Control device 201 performs traveling control of traveling body 61. Control device 201 controls actions of robot arm 11. In other words, control device 201 also functions as a robot controller. Note that self-propelled device 100 may include a control device that controls the traveling of traveling body 61 and a control device that controls the actions of robot arm 11 as separate devices.

Antenna 31 and the like are connected to communication interface 204. Self-propelled device 100 implements wireless communication between self-propelled device 100 and an external device (in the present example, information processing device 700) via antenna 31 and communication interface 204.

Laser sensor 205 is accommodated in cover portion 63 in FIG. 2. Laser sensor 205 detects an object around laser sensor 205 by irradiating surroundings with the laser beam while rotating itself, and receiving reflected light of the laser beam. Laser sensor 205 outputs a distance from laser sensor 205 to an object present in a scanning surface of the laser beam to control device 201 as two-dimensional distance data D representing the distance by angle around a rotation axis of laser sensor 205. The scanning surface of laser sensor 205 is inclined with respect to a horizontal surface. Therefore, self-propelled device 100 can three-dimensionally scan the surroundings by moving.

Motor driving device 206 controls rotation of first traveling motor 77 and second traveling motor 78 in accordance with a motor driving instruction from control device 201. The motor driving instruction includes, for example, forward rotation instructions for first traveling motor 77 and second traveling motor 78, reverse rotation instructions for first traveling motor 77 and second traveling motor 78, and rotation rates (rotation speeds) of first traveling motor 77 and second traveling motor 78.

Storage device 210 is, for example, a storage medium such as a hard disk or a flash memory. Storage device 210 stores, for example, control program 211 for controlling the actions of self-propelled device 100, and a three-dimensional map 212 of a traveling area. In detail, control program 211 includes a program for controlling the traveling of traveling body 61 and a program for controlling the actions of robot arm 11. Note that control program 211 and three-dimensional map 212 are not limited to storage device 210, and may be stored, for example, in a storage region (for example, a cache memory) of control device 201, ROM 202, RAM 203, or an external device (for example, a server).

Further, control program 211 may be provided not as a single program but by being incorporated in a part of any program. In this case, a traveling control process of traveling body 61 and an action control process of robot arm 11 by control program 211 are implemented in cooperation with the any program.

The program does not depart from the gist of control program 211 according to the present embodiment, even though the program does not include a part of modules. Moreover, some or all of functions to be provided by control program 211 may be implemented by a dedicated hardware. Moreover, self-propelled device 100 may be configured in a form such as a so-called cloud service in which at least one server executes a part of processes of control program 211.

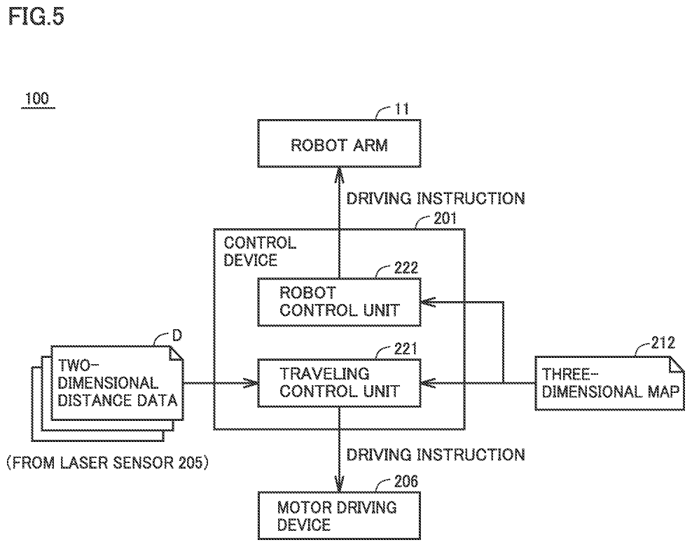

FIG. 5 is a diagram illustrating a function configuration related to the action control of self-propelled device 100.

As illustrated in FIG. 5, control device 201 includes a traveling control unit 221 and a robot control unit 222 as an example of the function configuration.

Traveling control unit 221 is a function configuration for controlling the traveling of self-propelled device 100. Traveling control unit 221 specifies a current position of self-propelled device 100 by comparing two-dimensional distance data D to be input from laser sensor 205 with three-dimensional map 212. Control device 201 causes self-propelled device 100 to travel along a predetermined route on three-dimensional map 212 by specifying the current position.

Moreover, traveling control unit 221 detects an obstacle around self-propelled device 100 based on two-dimensional distance data D to be sequentially acquired from laser sensor 205 during driving of self-propelled device 100, and controls the traveling of self-propelled device 100 to avoid collision with the obstacle. The obstacle includes, for example, a moving body such as a person or another self-propelled device 100, and a stationary body such as a wall or a shelf.

While no obstacle is being detected, traveling control unit 221 controls the traveling of self-propelled device 100 to travel along a predetermined route on three-dimensional map 212. In a case where the obstacle is detected, traveling control unit 221 controls the traveling of self-propelled device 100 to avoid the collision with the obstacle.

In an aspect, in a case where a distance to the obstacle is greater than or equal to a predetermined distance, traveling control unit 221 controls the traveling of self-propelled device 100 to avoid the obstacle. On the other hand, in a case where the distance to the obstacle is less than the predetermined distance, traveling control unit 221 stops the traveling of self-propelled device 100.

Robot control unit 222 is a function configuration for controlling the actions of robot arm 11 and end effector 40.

Robot control unit 222 controls actions of six movable portions (the six axes) of robot arm 11. Robot control unit 222 controls the swinging movement about each of rotation center axes 112, 113, and 115, and the rotational movement about each of rotation center axes 111, 114, and 116. Specifically, robot control unit 222 controls actions (for example, a rotation angle and a rotation speed) of an actuator (not illustrated) of robot arm 11.

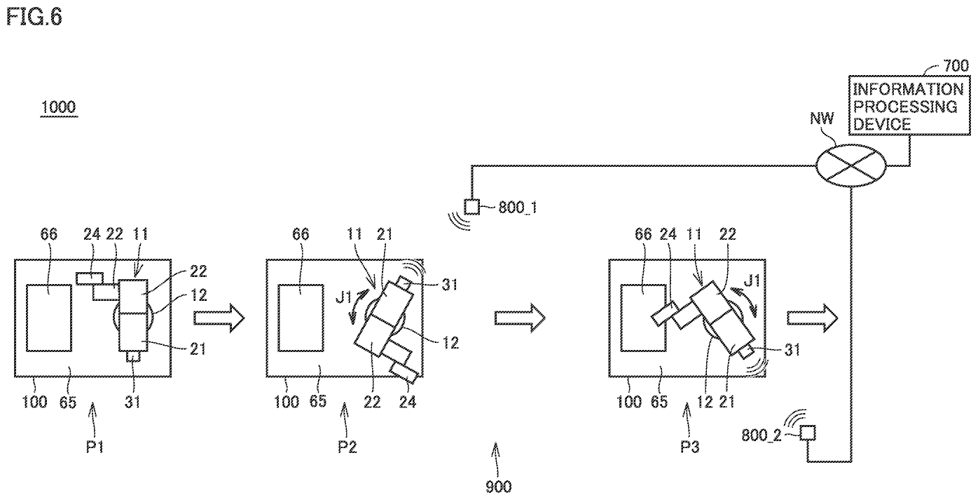

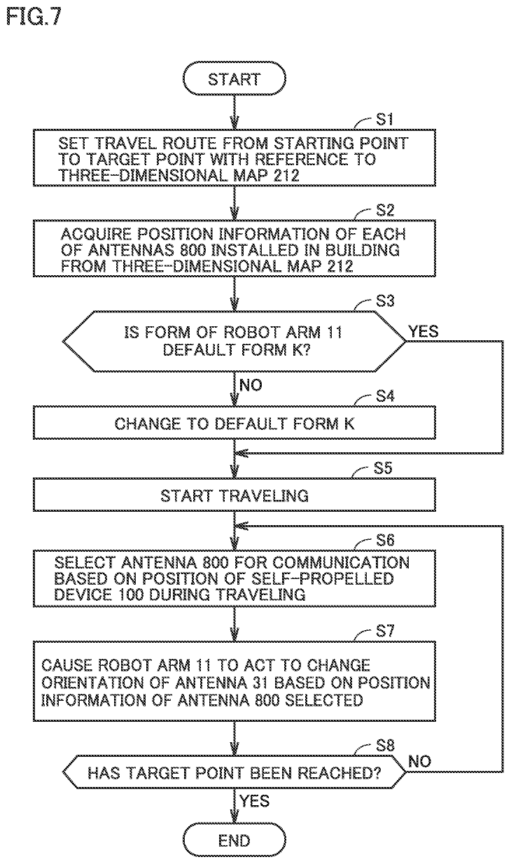

Moreover, robot control unit 222 controls movement of an electric hand of end effector 40. Robot control unit 222 controls a gripping action of the electric hand. Specifically, robot control unit 222 controls the actions of the actuator (not illustrated) in end effector 40. A control example of robot control unit 222 will be described later (FIGS. 6 and 7).

Further, control device 201 can also generate three-dimensional map 212. For convenience of description, generation of three-dimensional map 212 by control device 201 will be described in a second embodiment to be described later.

### Action Examples

FIG. 6 is a diagram illustrating the actions of self-propelled device 100.

As illustrated in FIG. 6, self-propelled device 100 departs from a point P1 and passes through a point P2 and a point P3 in this order. An antenna 800_1 is installed as antenna 800 on ceiling 950 (refer to FIG. 1) near point P2. Similarly, an antenna 800_2 is installed as antenna 800 on ceiling 950 near point P3.

Control device 201 controls robot arm 11 to cause arm portion 13 to be in a form that first arm portion 21 extends upward from base portion 12 toward joint portion 46, first arm portion 21 and second arm portion 22 are bent at joint portion 46, and second arm portion 22 extends downward from joint portion 46 toward wrist portion 24, when traveling body 61 travels. Hereinafter, such form of robot arm 11 is also referred to as “default form K”.

Typically, control device 201 controls a form of first arm portion 21 and a form of second arm portion 22 to cause the form of robot arm 11 to be in a state as illustrated in FIGS. 1 and 2. In other words, control device 201 controls the form of each portion such that base portion 12 does not rotate in an arrow J1 direction with respect to top surface 65, first arm portion 21 is oriented in the vertical direction, and an angle formed by first arm portion 21 and second arm portion 22 becomes a predetermined acute angle. Note that default form K is typically an initial form that robot arm transitions to, for example, when robot arm 11 is reset.

Control device 201 sequentially acquires mutual position information between antenna 31 and external antennas 800 (800_1, 800_2, . . . ) communicating with antenna 31 when traveling body 61 travels, and controls robot arm 11 to change an orientation of antenna 31 based on the position information acquired. Note that positions of antennas 800 are stored in advance in three-dimensional map 212.

In an example of FIG. 6, as traveling body 61 starts traveling, control device 201 changes the orientation of antenna 31 by rotating base portion 12 in the arrow J1 direction. In other words, control device 201 changes the position of antenna 31 with respect to rotation center axis 111 by rotating base portion 12 in the arrow J1 direction. In detail, control device 201 changes the position of antenna 31 in a local coordinate system in self-propelled device 100.

Typically, control device 201 controls a rotation angle of base portion 12 in the arrow J1 direction based on the position of self-propelled device 100 and a position of antenna 800 closest to self-propelled device 100 among the plurality of antennas 800. Specifically, control device 201 controls the rotation angle of base portion 12 in the arrow J1 direction to cause antenna 31 to face antenna 800 closest to self-propelled device 100 among the plurality of antennas 800. In detail, control device 201 controls the rotation angle of base portion 12 in the arrow J1 direction to cause a distance between antenna 31 and antenna 800 closest to self-propelled device 100 among the plurality of antennas 800 to become shortest.

Control device 201 may further control the rotation angle of base portion 12 in the arrow J1 direction in consideration of directivity of antenna 31. Control device 201 may control the rotation angle of base portion 12 in the arrow J1 direction in consideration of the directivity of antenna 31 and directivity of antennas 800.

In the example of FIG. 6, self-propelled device 100 starts rotation of base portion 12 in the arrow J1 direction, as the self-propelled device approaches antenna 800_1. In a case where antenna 800 closest to self-propelled device 100 is antenna 800_2, self-propelled device 100 further rotates base portion 12 in the arrow J1 direction to cause antenna 31 to face a direction of antenna 800_2.

<Control Structure>

FIG. 7 is a flowchart illustrating a flow of controlling the orientation of antenna 31.

As illustrated in FIG. 7, in step S1, control device 201 sets a travel route from a starting point to a target point with reference to three-dimensional map 212. The setting is typically performed based on instructions from information processing device 700.

In step S2, control device 201 acquires position information of each of antennas 800 installed in the building from three-dimensional map 212. In step S3, control device 201 determines whether or not the form of robot arm 11 is default form K.

In a case where it is determined that the form of robot arm 11 is not default form K (NO in step S3), control device 201 changes the form of robot arm 11 to default form K in step S4. Thereafter, control device 201 causes the process to proceed to step S5. Further, in a case where it is determined that the form of robot arm 11 is default form K (YES in step S3), control device 201 causes the process to proceed to step S5.

In step S5, control device 201 starts the traveling of self-propelled device 100. Control device 201 typically drives first traveling motor 77 and second traveling motor 78.

In step S6, control device 201 selects antenna 800 for communication among the plurality of antennas 800 installed in the building based on the position of self-propelled device 100 during the traveling. In step S7, the orientation of antenna 31 is changed based on the position information of antenna 800 selected. In the present example, the orientation of the antenna is changed by rotating base portion 12 in the arrow J1 direction.

In step S8, control device 201 determines whether or not self-propelled device 100 has reached the target point. In a case where it is determined that the target point has not been reached (NO in step S8), control device 201 causes the process to return to step S6. In a case where it is determined that the target point has been reached (YES in step S8), control device 201 ends a series of processes.

### SUMMARY

A part of the configuration of self-propelled device 100 will be summarized as follows.

(1) Self-propelled device 100 includes traveling body 61 and robot arm 11 that is mounted on traveling body 61. Robot arm 11 includes base portion 12 that is turnably connected to traveling body 61; arm portion 13 that is connected to base portion 12; and end effector 40 that is detachably attached to the distal end of arm portion 13 and performs the work on the target. Self-propelled device 100 further includes additional apparatus 30 that is attached to arm portion 13. Additional apparatus 30 includes at least antenna 31.

According to such configuration, since antenna 31 acts together with arm portion 13 as robot arm 11 acts, degrees of freedom of the position, a form, or the orientation of antenna 31 can be increased. Accordingly, usability of antenna 31 can be improved with a simple configuration.

(2) Arm portion 13 includes first arm portion 21 that is pivotally connected to base portion 12; second arm portion 22 that is pivotally connected to first arm portion 21; and wrist portion 24 that is pivotally connected to second arm portion 22 and detachably attached with end effector 40. Antenna 31 is arranged at joint portion 46 where second arm portion 22 is connected to first arm portion 21.

According to such configuration, since antenna 31 is arranged at a corner portion that is a position away from traveling body 61, and formed by first arm portion 21 and second arm portion 22 at joint portion 46, interference with traveling body 61 or robot arm 11 in use of antenna 31 hardly occurs. Specifically, a radio wave to be communicated with antenna 31 is hardly blocked.

(3) Self-propelled device 100 further includes wiring 49 that is routed from antenna 31 toward traveling body 61. Antenna 31 is attached to first arm portion 21. According to such configuration, since antenna 31 is attached to a position closer to the traveling body 61 as compared with a case where antenna 31 is attached to second arm portion 22, routing of wiring from antenna 31 toward base portion 12 becomes easy.

(4) Traveling body 61 has top surface 65. Base portion 12 is connected to top surface 65. According to such configuration, antenna 31 can be arranged at a higher position.

(5) Self-propelled device 100 further includes control device 201 that controls self-propelled device 100. Control device 201 controls robot arm 11 to cause arm portion 13 to be in the form that first arm portion 21 extends upward from base portion 12 toward joint portion 46, first arm portion 21 and second arm portion 22 are bent at joint portion 46, and second arm portion 22 extends downward from joint portion 46 toward wrist portion 24, when traveling body 61 travels. According to such configuration, antenna 31 can be arranged at the higher position when traveling body 61 travels.

(6) Control device 201 sequentially acquires mutual position information between antenna 31 and antenna 800 communicating with antenna 31 when traveling body 61 travels, and controls robot arm 11 to change the orientation of antenna 31 based on the position information acquired.

According to such configuration, it is possible to obtain a good communication state between antenna 31 and antenna 800 even though a positional relationship between antenna 31 of self-propelled device 100 and antenna 800 installed in the building changes from moment to moment as traveling body 61 travels.

<Variation>

(1) Antenna 31 may be attached to second arm portion 22 instead of first arm portion 21. In this case, the degrees of freedom of the position, the form, or the orientation of antenna 31 can be further increased since actions of second arm portion 22 with respect to first arm portion 21 are added, as compared with a case where antenna 31 is attached to first arm portion 21.

(2) In the description above, a configuration in which antenna 800 having a distance closest to self-propelled device 100 is selected from the plurality of antennas 800 has been described as an example, but the present invention is not limited thereto. For example, control device 201 may select antenna 800 having a highest reception strength among the plurality of antennas 800 instead of antenna 800 closest to self-propelled device 100.

### Second Embodiment

A self-propelled device of another aspect to be used in traveling system 1000 illustrated in FIG. 1 will be described.

<Configuration of Self-Propelled Device>

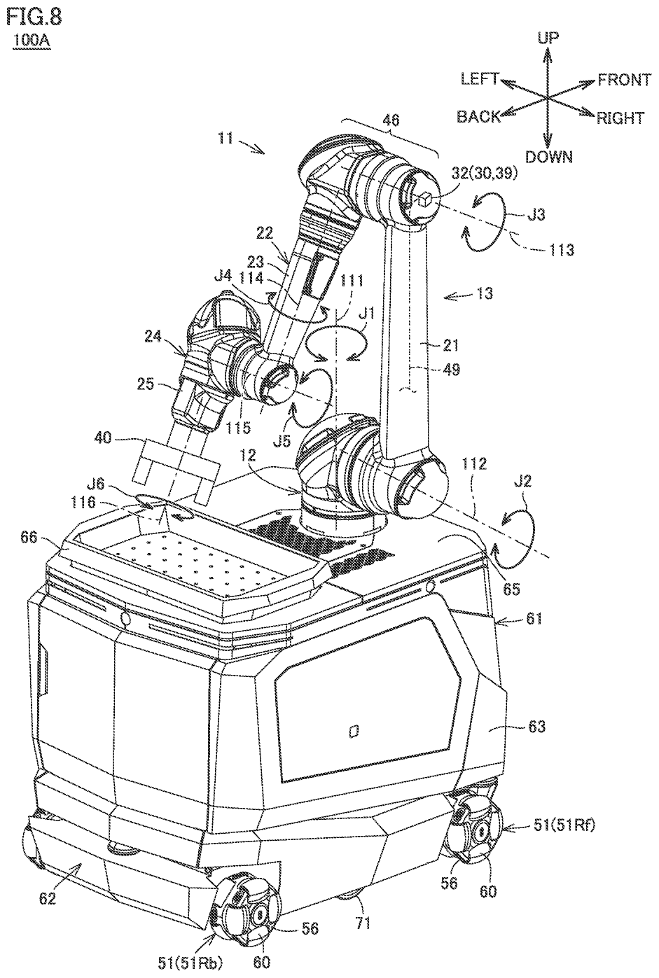

FIG. 8 is a perspective view illustrating a self-propelled device 100A of the present embodiment.

As illustrated in FIG. 8, self-propelled device 100A is different from self-propelled device 100 of the first embodiment in that a laser sensor 32 is disposed at a position of antenna 31. Specifically, self-propelled device 100A includes laser sensor 32 in arm portion 13 (in detail, joint portion 46) as additional apparatus 30.

Since self-propelled device 100A includes laser sensor 32, it is not necessary to include laser sensor 205 (FIG. 4) inside traveling body 61 like self-propelled device 100 of the first embodiment. Note that, in the present embodiment, antenna 31 is installed inside traveling body 61 (for example, a position where laser sensor 205 was installed).

Laser sensor 32 detects an object around laser sensor 32 by irradiating the surroundings with the laser beam and receiving the reflected light of the laser beam. Laser sensor 32 outputs a distance from laser sensor 32 to an object present in the scanning surface of the laser beam to control device 201 as two-dimensional distance data D representing the distance by angle around a rotation axis of laser sensor 32.

Laser sensor 205 of the first embodiment irradiates the surroundings with the laser beam while rotating by itself. Laser sensor 32 of the present embodiment irradiates the surroundings with the laser beam while changing the position, the form, and the orientation by the actions of robot arm 11 instead of the rotation by itself.

Typically, as traveling body 61 starts traveling, control device 201 changes an orientation of laser sensor 32 by rotating base portion 12 in the arrow J1 direction from a state in which the form of robot arm 11 is set to default form K described above. In other words, control device 201 changes a position of laser sensor 32 with respect to rotation center axis 111 by rotating base portion 12 in the arrow J1 direction. In detail, control device 201 changes the position of laser sensor 32 in the local coordinate system in self-propelled device 100A. Note that laser sensor 32 is used to detect the obstacle and create the three-dimensional map, similarly to laser sensor 205.

In the present embodiment, wiring 49 is routed from laser sensor 32 toward traveling body 61. Wiring 49 connects laser sensor 32 and control device 201 of self-propelled device 100A.

A hardware configuration of self-propelled device 100A is the same as the hardware configuration of self-propelled device 100 of the first embodiment except for differences above. Therefore, detailed description of the hardware configuration of self-propelled device 100A will not be repeated. Note that the hardware configuration is not limited to the configuration above, and antenna 31 and laser sensor 32 may be installed side by side at joint portion 46.

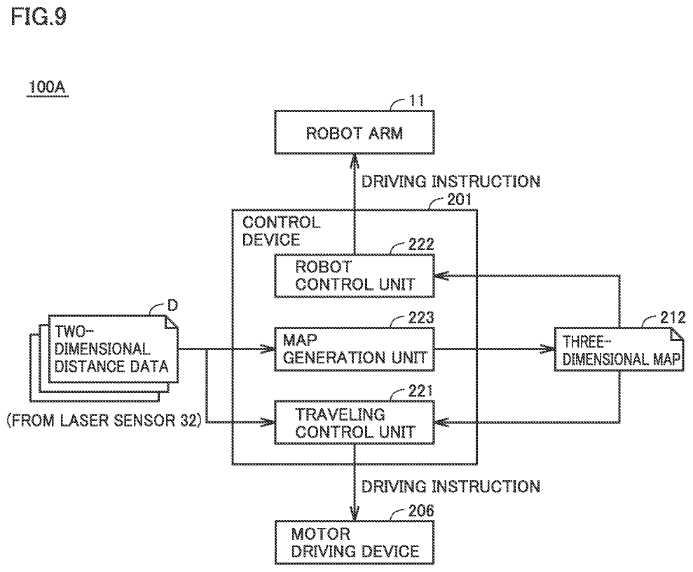

FIG. 9 is a diagram illustrating a function configuration related to an action control of self-propelled device 100A.

As illustrated in FIG. 9, control device 201 of self-propelled device 100A includes, as an example of the function configuration, traveling control unit 221, robot control unit 222, and a map generation unit 223.

In the first embodiment, control device 201 acquires two-dimensional distance data D from laser sensor 205 inside traveling body 61, but in the present embodiment, control device 201 acquires two-dimensional distance data D from laser sensor 32 attached to arm portion 13.

In the present embodiment, traveling control unit 221 specifies a current position of self-propelled device 100A by comparing two-dimensional distance data D to be input from laser sensor 32 with three-dimensional map 212. Control device 201 causes self-propelled device 100A to travel along a predetermined route on three-dimensional map 212 by specifying the current position.

Moreover, traveling control unit 221 detects an obstacle around self-propelled device 100A based on two-dimensional distance data D to be sequentially acquired from laser sensor 32 during driving of self-propelled device 100A, and controls the traveling of self-propelled device 100A to avoid collision with the obstacle. The obstacle includes, for example, a moving body such as a person or another self-propelled device 100A, and a stationary body such as a wall or a shelf.

Note that, since other processes (control) of traveling control unit 221 is the same as the process described with reference to FIG. 5 in the first embodiment, the description thereof will not be repeated.

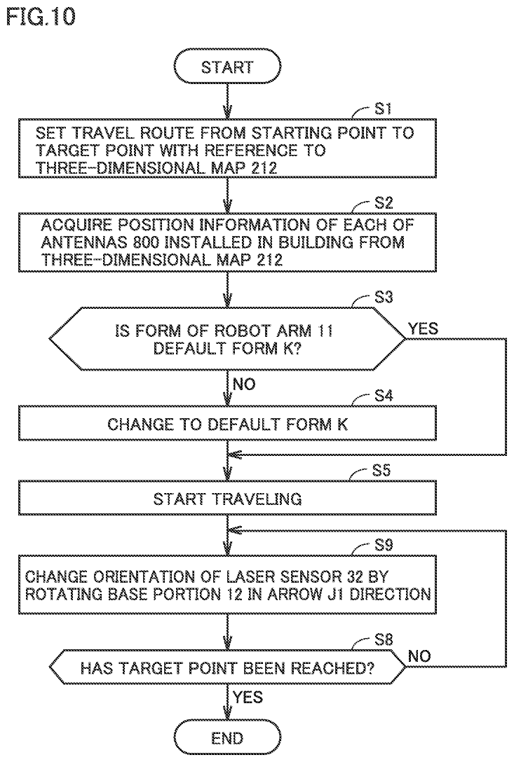

As described with reference to FIG. 5 in the first embodiment, robot control unit 222 is the function configuration for controlling the actions of robot arm 11 and end effector 40. The control example of robot control unit 222 in the present embodiment will be described later (FIG. 10).

A map generation unit 223 generates three-dimensional map 212 (three-dimensional data) representing a space around self-propelled device 100A based on two-dimensional distance data D to be sequentially acquired from laser sensor 32 during the driving of self-propelled device 100A.

Three-dimensional map 212 is generated by, for example, a simultaneous localization and mapping (SLAM) technique. Three-dimensional map 212 is information to be generated for specifying the position of self-propelled device 100A, and information indicating a position of a stationary object at a traveling place of self-propelled device 100A. The stationary object is, for example, a wall or a shelf.

Three-dimensional map 212 is generated, for example, by the user manually operating self-propelled device 100A with the user terminal. In this case, since an operation signal corresponding to a user operation is transmitted to control device 201 via antenna 31 and communication interface 204, control device 201 outputs an instruction to motor driving device 206 according to the operation signal, and controls the traveling of self-propelled device 100A. At this time, control device 201 maps the position of an object around self-propelled device 100A on three-dimensional map 212 based on two-dimensional distance data D to be input from laser sensor 32 and the position of self-propelled device 100A. The position of self-propelled device 100A is specified based on, for example, driving information of motor driving device 206. Accordingly, information indicating presence or absence of the object is associated with each of three-dimensional coordinate values (x, y, z) in three-dimensional map 212.

In self-propelled device 100A, the scanning surface of laser sensor 32 can be inclined with respect to the horizontal plane by movement of first arm portion 21. Therefore, self-propelled device 100A can three-dimensionally scan the surroundings by moving.

Note that map generation unit 223 does not need to use a laser sensor capable of measuring a three-dimensional shape (hereinafter, also referred to as “three-dimensional laser sensor”) during the generation of three-dimensional map 212. Since the three-dimensional laser sensor is very expensive, cost of self-propelled device 100A can be greatly reduced without the three-dimensional laser sensor.

<Control Structure>

FIG. 10 is a flowchart illustrating a flow of controlling the orientation of laser sensor 32 during normal traveling.

As illustrated in FIG. 10, in steps S1 to S5 and S8, the same process as the process illustrated in FIG. 7 is executed. Step S9 is performed instead of step S6 and step S7. Therefore, the following description focuses on a process of step S9.

In step S9, control device 201 changes the orientation of laser sensor 32 by rotating base portion 12 in the arrow J1 direction. In other words, control device 201 changes the position of laser sensor 32 with respect to rotation center axis 111 by rotating base portion 12 in the arrow J1 direction. In detail, control device 201 changes the position of laser sensor 32 in a local coordinate system in self-propelled device 100A.

In more detail, control device 201 rotates base portion 12 in the arrow J1 direction at a constant speed. Accordingly, control device 201 detects the obstacle in the surroundings. It is preferable to increase the rotation speed as a traveling speed of self-propelled device 100A increases. Note that, after step S9, control device 201 causes the process to proceed to step S8.

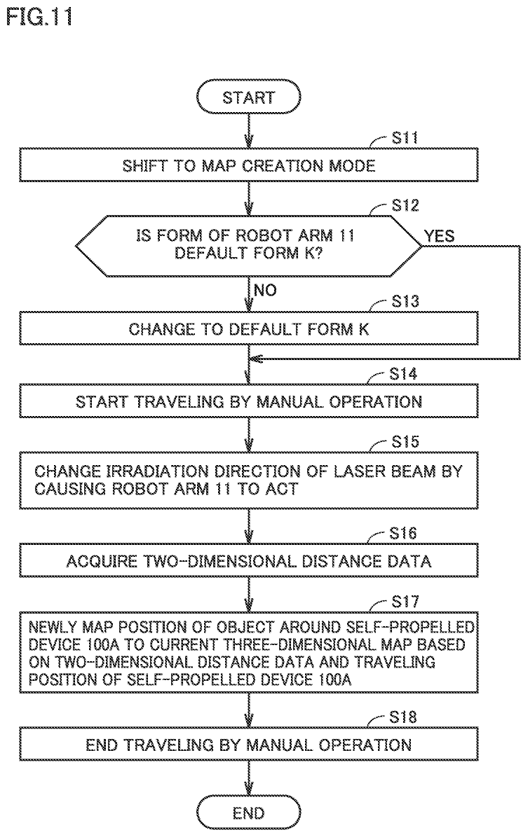

FIG. 11 is a flowchart illustrating a flow of controlling the orientation of laser sensor 32 during the creation of the three-dimensional map.

As illustrated in FIG. 11, in response to an indication from the user, control device 201 shifts an operation mode of self-propelled device 100A to a map creation mode in step S11. In step S12, control device 201 determines whether or not the form of robot arm 11 is default form K.

In a case where it is determined that the form of robot arm 11 is not default form K (NO in step S12), control device 201 changes the form of robot arm 11 to default form K in step S13. Thereafter, control device 201 causes the process to proceed to step S14. Further, in a case where it is determined that the form of robot arm 11 is default form K (YES in step S12), control device 201 causes the process to proceed to step S14.

In step S14, self-propelled device 100A starts traveling by manual operations of the user. Self-propelled device 100A travels in various places in the building based on an indication of the user. In step S15, control device 201 starts irradiating with the laser beam by laser sensor 32 and changes an irradiation direction of the laser beam by causing robot arm 11 to act. The irradiation direction of the laser may be changed automatically by control device 201 or may be changed based on a user operation.

In step S16, control device 201 sequentially acquires two-dimensional distance data D based on the irradiation with the laser beam. In detail, control device 201 measures a distance from self-propelled device 100A to the object based on the period from the irradiation with the laser beam to the reception of the laser beam.

In step S17, control device 201 sequentially maps the position of the object around self-propelled device 100A on a current three-dimensional map (a three-dimensional map that is being created) based on two-dimensional distance data D and a traveling position of self-propelled device 100A. In step S18, in a case where the traveling in a range (a region of the building) desired by the user ends, self-propelled device 100A ends the traveling by a manual operation of the user.

Note that, in the description above, a case where self-propelled device 100A creates three-dimensional map 212 has been described as an example, but the present invention is not limited thereto. Information processing device 700 may create three-dimensional map 212 by causing self-propelled device 100A to transmit the position of self-propelled device 100A, two-dimensional distance data obtained at the position, and orientation data of laser sensor 32 to information processing device 700. Note that, in this case, the three-dimensional map created by information processing device 700 is then transmitted to self-propelled device 100A.

### SUMMARY

A part of the configuration of self-propelled device 100A will be summarized as follows.

(1) Self-propelled device 100A includes additional apparatus 30 that is attached to arm portion 13. Additional apparatus 30 includes at least laser sensor 32. According to such configuration, since laser sensor 32 acts together with arm portion 13 as robot arm 11 acts, degrees of freedom of the position, the form, or the orientation of laser sensor 32 can be increased. Accordingly, usability of laser sensor 32 can be improved with a simple configuration.

(2) Laser sensor 32 is arranged at joint portion 46 where second arm portion 22 is connected to first arm portion 21. According to such configuration, since laser sensor 32 is arranged at the corner portion that is the position away from traveling body 61, and formed by first arm portion 21 and second arm portion 22 at joint portion 46, interference with traveling body 61 or robot arm 11 in use of laser sensor 32 hardly occurs. Specifically, the laser beam from laser sensor 32 is hardly blocked.

(3) Self-propelled device 100A includes wiring 49 that is routed from laser sensor 32 toward traveling body 61. Laser sensor 32 is attached to first arm portion 21. According to such configuration, since laser sensor 32 is attached to a position closer to the traveling body 61 as compared with a case where laser sensor 32 is attached to second arm portion 22, routing of wiring from laser sensor 32 toward base portion 12 becomes easy.

(4) Base portion 12 is connected to top surface 65. According to such configuration, laser sensor 32 can be arranged at a higher position.

(5) Control device 201 controls robot arm 11 to cause arm portion 13 to be in the form that first arm portion 21 extends upward from base portion 12 toward joint portion 46, first arm portion 21 and second arm portion 22 are bent at joint portion 46, and second arm portion 22 extends downward from joint portion 46 toward wrist portion 24, when traveling body 61 travels. According to such configuration, laser sensor 32 can be arranged at the higher position when traveling body 61 travels.

(6) Additional apparatus 30 includes laser sensor 32 that receives the reflected light of the laser beam reflected by the object around self-propelled device 100A while the irradiation is being performed with the laser beam. Control device 201 controls robot arm 11 to cause arm portion 13 to act while the irradiation is performed with the laser beam from laser sensor 32. Control device 201 measures the distance from self-propelled device 100A to the object above based on the period from the irradiation with the laser beam to the reception of the laser beam, and generates map data (in the present example, three-dimensional map 212) around self-propelled device 100A.

According to such configuration, self-propelled device 100A can change the irradiation direction of the laser beam by causing arm portion 13 to act. Accordingly, the map data can be generated more accurately with smaller number of laser sensors 32.

<Variation>

In the present embodiment, the configuration in which laser sensor 32 is included in joint portion 46 has been described as an example, but self-propelled device 100A may include an ultrasonic sensor 39 instead of laser sensor 32. According to such configuration, since ultrasonic sensor 39 is arranged at joint portion 46 where second arm portion 22 is connected to first arm portion 21, an ultrasonic wave from ultrasonic sensor 39 is hardly blocked.

Further, in this case, control device 201 controls robot arm 11 to cause arm portion 13 to act while irradiation is performed with the ultrasonic wave from ultrasonic sensor 39. Control device 201 measures the distance from self-propelled device 100A to the object above based on the period from the irradiation of the ultrasonic wave to the reception of the ultrasonic wave, and generates the map data around self-propelled device 100A. Accordingly, the map data can be generated more accurately with smaller number of ultrasonic sensors 39.

### Third Embodiment

A self-propelled device of still another embodiment to be used in traveling system 1000 illustrated in FIG. 1 will be described.

<Configuration of Self-Propelled Device>

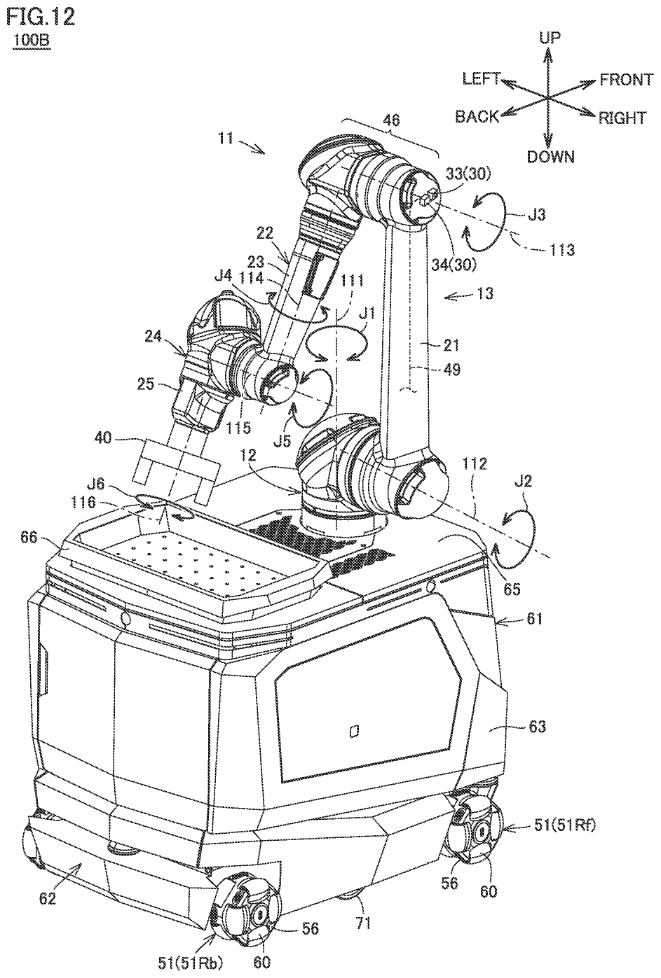

FIG. 12 is a perspective view illustrating a self-propelled device 100B of the present embodiment.

As illustrated in FIG. 12, self-propelled device 100B is different from self-propelled device 100 of the first embodiment in that an imaging device 33 and a lighting device 34 are disposed at the position of antenna 31. Specifically, self-propelled device 100B includes imaging device 33 and lighting device 34 in arm portion 13 (in detail, joint portion 46) as additional apparatus 30. Note that, in the present embodiment, antenna 31 is installed inside traveling body 61. Since self-propelled device 100B includes imaging device 33 and lighting device 34, self-propelled device 100B may not include laser sensor 205 (FIG. 4).

Similarly to laser sensors 205 and 32, imaging device 33 and lighting device 34 are used for detecting the obstacle. Imaging device 33 is typically a digital camera. Imaging device 33 can image at least a moving image.

Further, imaging device 33 can image a region to be irradiated with light by lighting device 34. Typically, lighting device 34 performs irradiation with the light in an orientation of an optical axis of a lens of imaging device 33. Note that imaging device 33 and lighting device 34 may be housed in one housing. In other words, imaging device 33 and lighting device 34 may be provided as a single apparatus.

Control device 201 changes orientations of imaging device 33 and lighting device 34 by rotating base portion 12 in the arrow J1 direction. In other words, control device 201 changes the position of imaging device 33 and lighting device 34 with respect to rotation center axis 111 by rotating base portion 12 in the arrow J1 direction. In detail, control device 201 changes positions of imaging device 33 and lighting device 34 in a local coordinate system in self-propelled device 100B.

Accordingly, control device 201 can acquire an image around self-propelled device 100B. Control device 201 detects presence or absence of the obstacle based on the image acquired and three-dimensional map 212.

When it is dark inside the building at night or the like (for example, a predetermined time zone during nighttime), self-propelled device 100B starts traveling by traveling body 61 after confirming safety around self-propelled device 100B by imaging with imaging device 33. Further, self-propelled device 100B also can start imaging and end imaging based on, for example, indications of the user.

In the present embodiment, wiring 49 is routed from imaging device 33 and lighting device 34 toward traveling body 61. Wiring 49 connects imaging device 33 and lighting device 34 to control device 201 of self-propelled device 100B.

Note that self-propelled device 100B may not necessarily include lighting device 34. For example, in a case where a camera having a high sensitivity is used as imaging device 33, lighting device 34 may not be included. Further, in a case where self-propelled device 100B always acts under an environment of a certain level of illuminance or higher, self-propelled device 100B may not include lighting device 34.

A hardware configuration of self-propelled device 100B is the same as the hardware configuration of self-propelled device 100 of the first embodiment except for differences above. Therefore, the detailed description of the hardware configuration of self-propelled device 100B will be not repeated. Note that the configuration is not limited to the configuration above, and antenna 31, laser sensor 32, imaging device 33, and lighting device 34 may be installed side by side at joint portion 46.

### SUMMARY

A part of the configuration of self-propelled device 100B will be summarized as follows.

(1) Self-propelled device 100B includes additional apparatus 30 that is attached to arm portion 13. Additional apparatus 30 includes at least lighting device 34 and imaging device 33 capable of imaging the region to be irradiated with the light by lighting device 34. According to such configuration, since imaging device 33 and lighting device 34 act together with arm portion 13 as robot arm 11 acts, degrees of freedom of positions, forms, or orientations of imaging device 33 and lighting device 34 can be increased. Accordingly, usability of imaging device 33 and lighting device 34 can be improved with a simple configuration. Further, the region to be irradiated by lighting device 34 can be imaged by imaging device 33 while the region is being moved by causing arm portion 13 to act.

(2) Imaging device 33 and lighting device 34 are arranged at joint portion 46 where second arm portion 22 is connected to first arm portion 21. According to such configuration, since imaging device 33 and lighting device 34 are arranged at the corner portion that is the position away from traveling body 61, and formed by first arm portion 21 and second arm portion 22 at joint portion 46, interference with traveling body 61 or robot arm 11 in use of imaging device 33 and lighting device 34 hardly occurs. Specifically, the light from lighting device 34 is hardly blocked.

(3) Self-propelled device 100B includes wiring 49 that is routed from imaging device 33 and lighting device 34 toward traveling body 61. Imaging device 33 and lighting device 34 are attached to first arm portion 21. According to such configuration, since imaging device 33 and lighting device 34 are attached to a position closer to the traveling body 61 as compared with a case where imaging device 33 and lighting device 34 are attached to second arm portion 22, routing of wiring from imaging device 33 and lighting device 34 toward base portion 12 becomes easy.

(4) Base portion 12 is connected to top surface 65. According to such configuration, imaging device 33 and lighting device 34 can be arranged at a higher position.

(5) Control device 201 controls robot arm 11 to cause arm portion 13 to be in the form that first arm portion 21 extends upward from base portion 12 toward joint portion 46, first arm portion 21 and second arm portion 22 are bent at joint portion 46, and second arm portion 22 extends downward from joint portion 46 toward wrist portion 24, when traveling body 61 travels. According to such configuration, imaging device 33 and lighting device 34 can be arranged at the higher position when traveling body 61 travels.

<Variation Common to All Embodiments>

In each of the first embodiment to the third embodiment, specific configuration examples of additional apparatus 30 have been described, but the configuration of additional apparatus 30 is not limited to the above. It is only necessary that additional apparatus 30 includes at least one of the antenna, the imaging device, the laser sensor, the ultrasonic sensor, and the lighting device, and is attached to arm portion 13.

It is only necessary that an attachment place of additional apparatus 30 is arm portion 13, and the attachment place is not limited to joint portion 46. By attaching additional apparatus 30 to a distal end side (for example, first rotation portion 23 or wrist portion 24) of arm portion 13, the position, the form, and the orientation of additional apparatus 30 can be complicatedly controlled. It is possible to further hold additional apparatus 30 at a higher position rather than arranging additional apparatus 30 at joint portion 46.

Further, in the descriptions above, configurations in which self-propelled devices 100, 100A, 100B, and the like perform, for example, the communication, the scanning, or the imaging while being self-propelled in default form K (refer to FIGS. 1, 2, 8, and 12) have been described as examples, but the present invention is not limited thereto. However, in a case where additional apparatus 30 is attached to joint portion 46, control device 201 preferably controls first arm portion 21 to be oriented in the vertical direction to place additional apparatus 30 at a high position.

The embodiments disclosed herein are examples, and the present invention is not limited only to content above. The scope of the present invention is defined by claims, and it is intended that meanings equivalent to the claims and all modifications within the scope are included.

What is claimed is:

1. A self-propelled device comprising:
a traveling body;
a robot arm that is mounted on the traveling body; and
a control device that controls the self-propelled device,
wherein the robot arm includes:
a base portion that is turnably connected to the traveling body;
an arm portion that is connected to the base portion; and
an end effector that is detachably attached to a distal end of the arm portion and performs work on a target,
the self-propelled device further comprising an additional apparatus that includes an antenna and is attached to the arm portion,
wherein the control device sequentially acquires mutual position information between the antenna and an external antenna communicating with the antenna when the traveling body travels, and controls the robot arm to change an orientation of the antenna based on the position information acquired.

2. The self-propelled device according to claim 1, wherein
the arm portion includes:
a first arm portion that is pivotally connected to the base portion;
a second arm portion that is pivotally connected to the first arm portion; and
a wrist portion that is pivotally connected to the second arm portion and detachably attached with the end effector, and
the additional apparatus is disposed at a joint portion where the second arm portion is connected to the first arm portion.

3. The self-propelled device according to claim 2, further comprising a wiring that is routed from the additional apparatus toward the traveling body,
wherein the additional apparatus is attached to the first arm portion.

4. The self-propelled device according to claim 2, wherein the additional apparatus is attached to the second arm portion.

5. The self-propelled device according to claim 2, wherein the control device controls the robot arm to cause the arm portion to be in a form that the first arm portion extends upward from the base portion toward the joint portion, the first arm portion and the second arm portion are bent at the joint portion, and the second arm portion extends downward from the joint portion toward the wrist portion, when the traveling body travels.

6. The self-propelled device according to claim 1, wherein
the traveling body has a top surface, and
the base portion is connected to the top surface.
